(19) United States
(12) Patent Application Publication
(10) Pub. No.: US 2020/0174511 A1
(43) Pub. Date: Jun. 4, 2020

(54) POWER MANAGEMENT SYSTEM, POWER CONTROL APPARATUS, AND POWER MANAGEMENT METHOD

(71) Applicant: NEC CORPORATION, Tokyo (JP)

(72) Inventors: Hiroki TAKEUCHI, Tokyo (JP); Hidekazu KIMURA, Tokyo (JP)

(73) Assignee: NEC CORPORATION, Tokyo (JP)

(21) Appl. No.: 16/615,193

(22) PCT Filed: Dec. 25, 2017
(86) PCT No.: PCT/JP2017/046455

§ 371 Date: Nov. 20, 2019

(30) Foreign Application Priority Data
Jun. 16, 2017 (JP) 2017-118361

(51) Int. Cl. G05F 1/66; H02J 3/00; H02J 3/28; G06Q 50/06

(52) U.S. Cl. CPC G05F 1/66; G06Q 50/06; H02J 3/28; H02J 3/003

(57) ABSTRACT

A power control apparatus including: an acquisition unit that acquires “X(t)” which is a time function of output demand power P_{DEM} [W] in an output demand time period; a maximum power amount determination unit that determines a maximum power amount PH_{MAX} [Wh], which can be output from a power storage system in response to an output demand; a maximum power determination unit that determines maximum power P_{MAX} [W], which can be output from the power storage system in response to the output demand; and an output power determination unit that determines “a×X(t)” as a time function of output power P_{RES} [W], which is output from the power storage system in response to the output demand, and that determines a value of “a” so as to satisfy a first condition expressed by PH_{MAX}, a second condition expressed by P_{MAX}, and a third condition “0≤a≤1”.

### TECHNICAL FIELD

The present invention relates to a power management system, a power control apparatus, a power management method, and a program.

### BACKGROUND ART

Patent Document 1 discloses a technology related to an energy demand response. In the technology, an aggregator centrally manages energy of a plurality of power consumers. Further, the aggregator determines a demand response plan such that advantages of both the aggregator and the power consumers can be ensured.

Patent Document 2 discloses a technology for adjusting a balance between demand and supply by determining excess or shortage of power on the basis of supply and demand prediction of each of the power consumers and adjusting a unit cost of the power on the basis of a result of the determination. Specifically, a value, which is acquired by multiplying a surplus or a shortage by a conversion coefficient, is computed as an adjustment amount of the unit cost of the power, and the value is distributed to the consumers at a predetermined distribution ratio. Further, setting of the unit cost of the power is performed on the basis of a standard unit cost and the distributed adjustment amount of the unit cost of the power.

Patent Document 3 discloses prediction of the amount of loads of the consumers (the amount of power consumed by the consumers) and the amount of generation of the consumers (the amount of power generated by the consumers).

Patent Document 4 discloses a technology for selecting a replacement method in a case where the reduction amount of power consumption notified by power consumers is insufficient with respect to the reduction amount demanded from an electric power provider. In the technology, for example, a procurement price of the power by a generator is compared with a procurement price of the power in a power trading market, and the replacement method in which the procurement price is low is selected.

### RELATED DOCUMENT

### Patent Document

[Patent Document 1] Japanese Unexamined Patent Application Publication No. 2016-170647

[Patent Document 2] Japanese Unexamined Patent Application Publication No. 2016-46922

[Patent Document 3] Japanese Unexamined Patent Application Publication No. 2016-25829

[Patent Document 4] Japanese Unexamined Patent Application Publication No. 2014-164729

### SUMMARY OF THE INVENTION

### Technical Problem

In demand response, in which power is supplied to a power system from a power storage system of a power consumer in response to an output demand from an electric utility, the following problems are detected.

For example, the electric utility makes the output demand by designating a time period (hereinafter, referred to as an “output demand time period”), in which the power is output, a temporal variation in output demand power [W] in the time period, and the like. Here, a problem occurs in a case where only a part of the output demand is acceded to instead of the entire output demand.

For example, in the output demand time period, a time period in which the output demand is acceded to and a time period in which the output demand is not acceded to may occur. In addition, even in the time period in which the output demand is acceded to, a ratio (a ratio of the power in which the demand is acceded to in the output demand power) of acceding to the output demand may be different.

In this case, the temporal variation in power (residue), which remains due to the output demand not being acceded to, becomes irregular, and thus a sudden increase or decrease may be included. Although it is necessary to perform output with respect to the residue using any power generation system, it is difficult to perform output control according to the residue which may include the sudden increase or decrease.

An object of the present invention is to prevent a problem in that it is difficult to perform the output control with respect to the residue in a case of acceding to a part of the output demand from the electric utility.

### Solution to Problem

According to the present invention, there is provided a power management system including: an acquisition unit that acquires “X(t)” which is a time function of output demand power P_{DEM} [W] in an output demand time period; a maximum power amount determination unit that determines a maximum power amount PH_{MAX} [Wh], which can be output from a power storage system in response to an output demand, for each power consumer; a maximum power determination unit that determines maximum power P_{MAX} [W], which can be output from the power storage system in response to the output demand, for each power consumer; and an output power determination unit that determines “a×X(t)” as a time function of output power P_{RES} [W], which is output from the power storage system in response to the output demand, for each power consumer, and that determines a value of “a” so as to satisfy a first condition expressed by PH_{MAX}, a second condition expressed by P_{MAX}, and a third condition “0≤a≤1”.

In addition, according to the present invention, there is provided a power control apparatus including: an acquisition unit that acquires “X(t)” which is a time function of output demand power P_{DEM} [W] in an output demand time period; a maximum power amount determination unit that determines a maximum power amount PH_{MAX} [Wh], which can be output from a power storage system in response to an output demand, for each power consumer; a maximum power determination unit that determines maximum power P_{MAX} [W], which can be output from the power storage system in response to the output demand, for each power consumer; and an output power determination unit that determines “a×X(t)” as a time function of output power P_{RES} [W], which is output from the power storage system in response to the output demand, for each power consumer, and that determines a value of “a” so as to satisfy a first condition expressed by PH_{MAX}, a second condition expressed by P_{MAX}, and a third condition “0≤a≤1”.

In addition, according to the present invention, there is provided a power management method executed by a computer, the method including: acquiring “X(t)” which is a time function of output demand power P_{DEM} [W] in an output demand time period; determining a maximum power amount PH_{MAX} [Wh], which can be output from a power storage system in response to an output demand, for each power consumer; determining maximum power P_{MAX} [W], which can be output from the power storage system in response to the output demand, for each power consumer; and determining “a×X(t)” as a time function of output power P_{RES} [W], which is output from the power storage system in response to the output demand, for each power consumer, and determining a value of “a” so as to satisfy a first condition expressed by PH_{MAX}, a second condition expressed by P_{MAX}, and a third condition “0≤a≤1”.

In addition, according to the present invention, there is provided a program causing a computer to function as: an acquisition unit that acquires “X(t)” which is a time function of output demand power P_{DEM} [W] in an output demand time period; a maximum power amount determination unit that determines a maximum power amount PH_{MAX} [Wh], which can be output from a power storage system in response to an output demand, for each power consumer; a maximum power determination unit that determines maximum power P_{MAX} [W], which can be output from the power storage system in response to the output demand, for each power consumer; and an output power determination unit that determines “a×X(t)” as a time function of output power P_{RES} [W], which is output from the power storage system in response to the output demand, for each power consumer, and that determines a value of “a” so as to satisfy a first condition expressed by PH_{MAX}, a second condition expressed by P_{MAX}, and a third condition “0≤a≤1”.

### Advantageous Effects of Invention

According to the present invention, even in a case where a part of the output demand from the electric utility is acceded to, output control with respect to the residue is relatively easy.

### BRIEF DESCRIPTION OF THE DRAWINGS

The above-described object, the other objects, features, and advantages will be apparent by preferable example embodiments, which will be described below, and drawings accompanying with the example embodiments.

FIG. 1 illustrates an example of a functional block diagram of a power management system of an example embodiment.

FIG. 2 is a diagram illustrating an example of a hardware configuration of a power control apparatus of the example embodiment.

FIG. 3 illustrates an example of a functional block diagram of the power control apparatus of the example embodiment.

FIG. 4 is a diagram illustrating an example of output demand power P_{DEM} [W] of the example embodiment.

FIG. 5 is a flowchart illustrating an example of flow of a process performed by the power management system of the example embodiment.

FIG. 6 is a diagram illustrating an example of a residue [W] in which an output demand is not acceded to, according to the example embodiment.

FIG. 7 is a diagram illustrating an example of a residue [W], in which an output demand is not acceded to, according to a reference example.

FIG. 8 illustrates an example of a functional block diagram of the power control apparatus of the example embodiment.

FIG. 9 illustrates an example of a functional block diagram of a power consumer system of the example embodiment.

FIG. 10 is a flowchart illustrating an example of a flow of a process performed by the power management system of the example embodiment.

### DESCRIPTION OF EXAMPLE EMBODIMENTS

### First Example Embodiment

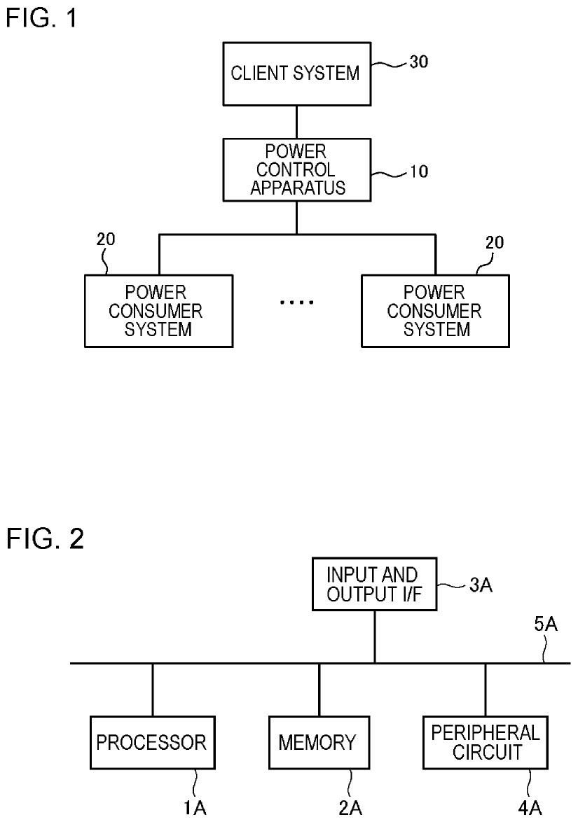

First, an entire structure and an outline of a power management system of an example embodiment will be described with reference to FIG. 1. The power management system includes a power control apparatus 10, a plurality of power consumer systems 20, and a client system 30. A plurality of client systems 30 may be provided.

The power consumer system 20 is a system for a power consumer. The power consumer system 20 includes a power storage system and an energy control apparatus (for example: a Home Energy Management System (HEMS), a Building Management System (BEMS), a Factory Management System (FEMS), a Community Management System (CEMS), and the like).

The energy control apparatus and the power storage system are connected to a Local Area Network (LAN) in the power consumer to be capable of performing communication. The power storage system is capable of controlling charge and discharge on the basis of control information received from an external apparatus (the energy control apparatus, the power control apparatus 10, or the like).

The power control apparatus 10 is an apparatus for an operator (resource aggregator) which provides a demand response service. The power control apparatus 10 may be a cloud server. The power control apparatus 10 communicates with the power consumer system 20 and the client system 30 through a communication network such as the Internet.

The power control apparatus 10 receives an output demand (a demand to supply power from the power storage system to a power system) from an electric utility. In addition, the power control apparatus 10 controls the plurality of power consumer systems 20. Specifically, the power control apparatus 10 determines a temporal change in output power [W], which is output from the power storage system in response to the output demand from the electric utility, for each of the power consumer systems 20, according to the output demand. Further, the power control apparatus 10 controls the power consumer systems 20 such that output is performed just as determined content.

The client system 30 is a system for the electric utility. The client system 30 communicates with the power control apparatus 10 through the communication network such as the Internet. The client system 30 transmits the output demand to the power control apparatus 10.

It is possible to realize a configuration of the power consumer systems 20 and the client system 30, which have the above-described functions, according to the related art. Hereinafter, a configuration of the power control apparatus 10 will be described in detail.

First, an example of a hardware configuration of the power control apparatus 10 will be described. Respective functional units included in the power control apparatus 10 of the example embodiment are configured with any combination of hardware and software based on a Central Processing Unit (CPU), a memory, a program loaded to the memory, a storage unit (it is possible to store a program, which is downloaded from a storage medium, such as a Compact Disc (CD), a server on the Internet, or the like, in addition to a program previously stored from a stage at which an apparatus is shipped), such as a hard disk which stores the program, and a network connection interface of any computer. Further, those skilled in the art understand that there are various modified examples of a method and an apparatus for configuration.

FIG. 2 is a block diagram illustrating the hardware configuration of the power control apparatus 10 of the example embodiment. As illustrated in FIG. 2, the power control apparatus includes a processor 1A, a memory 2A, an input and output interface 3A, a peripheral circuit 4A, and a bus 5A. The peripheral circuit 4A includes various modules. The power control apparatus 10 may include a plurality of apparatuses which are physically and/or logically separated. In this case, each of the plurality of apparatuses may include the processor 1A, the memory 2A, the input and output interface 3A, the peripheral circuit 4A, and the bus 5A.

The bus 5A is a data transmission channel provided for the processor 1A, the memory 2A, the peripheral circuit 4A, and the input and output interface 3A to mutually transmit and receive data. The processor 1A is, for example, an arithmetic processing unit such as the CPU or a Graphics Processing Unit (GPU). The memory 2A is, for example, a memory such as a Random Access Memory (RAM) or a Read Only Memory (ROM). The input and output interface 3A includes an interface for acquiring information from an input apparatus (for example: a keyboard, a mouse, a microphone, a physical key, a touch panel display, a code reader, or the like), an external apparatus, an external server, an external sensor, and the like, and an interface for outputting the information to an output apparatus (for example: a display, a speaker, a printer, a mailer, or the like), the external apparatus, the external server, and the like. The processor 1A is capable of outputting an instruction to each of the modules and performing an arithmetic operation based on an arithmetic result of each of the modules.

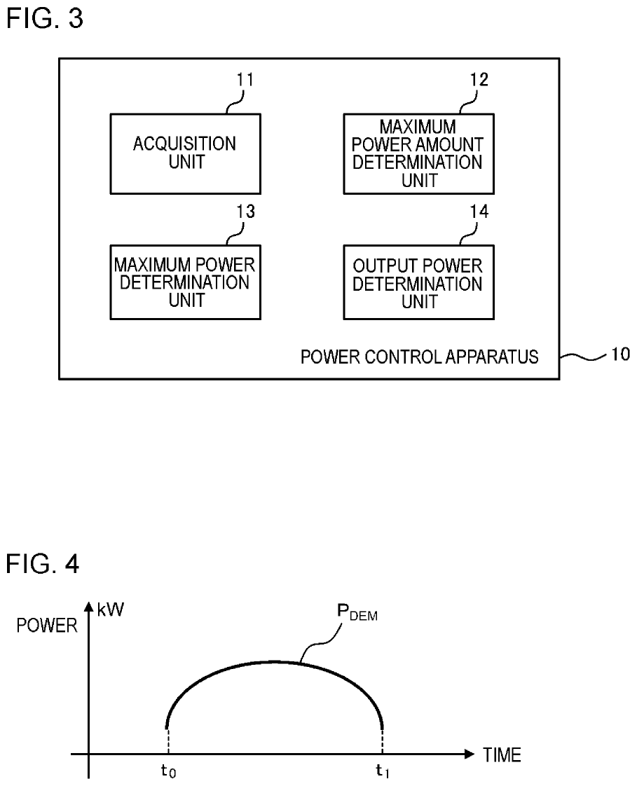

Subsequently, a functional configuration of the power control apparatus 10 will be described. FIG. 3 illustrates an example of a functional block diagram of the power control apparatus 10. As illustrated in the drawing, the power control apparatus 10 includes an acquisition unit 11, a maximum power amount determination unit 12, a maximum power determination unit 13, and an output power determination unit 14.

The acquisition unit 11 receives the output demand from the client system 30. The output demand includes information indicative of an output demand time period and a time function X(t) of output demand power P_{DEM} [W] of the output demand time period. For example, the acquisition unit 11 receives the output demand corresponding to a next day on the previous day thereof.

FIG. 4 is a diagram illustrating an example of the time function X(t) of the output demand power P_{DEM} [W]. A vertical axis indicates power and a horizontal axis indicates time. t=t₀ is a start time point of the output demand time period, and t=t₁ is an end time point of the output demand time period.

In the specification, “acquisition” includes at least any one of the own device's fetching (active acquisition) data or information, which is stored in another apparatus or the storage medium, for example, receiving through demanding or inquiring of another apparatus, reading through accessing another apparatus or the storage medium, and inputting (passive acquisition) the data or information, which is output from another apparatus, to the own device, for example, receiving the data or information which is delivered (or transmitted, push-notified, or the like). In addition, the “acquisition” includes acquiring through selection from among the received data or information or receiving through selection of the delivered data or information.

Returning to FIG. 3, the maximum power amount determination unit 12 determines a maximum power amount PH_{MAX} [Wh] which can be output from the power storage system in response to the output demand for each power consumer.

The maximum power amount determination unit 12 can determine PH_{MAX} on the basis of a “charge schedule of the power storage system” and a “discharge schedule of each of the power consumers”. Specifically, the maximum power amount determination unit 12 can set “a predicted value of a charged power amount [Wh] of the power storage system at a predetermined timing after the end time point (in FIG. 4, t₁) of the output demand time period”, the predicted value being computed on the basis of the two schedules, to PH_{MAX}. It is preferable that the predetermined timing is set to the end time point (in FIG. 4, t₁) of the output demand time period. The reason for this will be described in advantageous effects below.

The charge schedule of the power storage system is a schedule of receiving power from the power system and charging the power. For example, the power storage system is scheduled to be charged up to full charge in a first time period (during night, for example, from 22 o'clock to 5 o'clock). In this case, the power storage system is fully charged at an end time point of the first time period. The power charged in the first time period is output from the power storage system at a second time period (during day time, for example, from 5 o'clock to 22 o'clock), and is consumed.

The discharge schedule of each of the power consumers is, for example, prediction of temporal change in power consumption (self-consumption) due to loads (for example: home appliances, machines, facilities, and the like) of each of the power consumers. For example, it is possible to perform computation based on past performance of each of the power consumers, an attribute of the day (for example: a month, a day of a week, weather, a temperature, or the like). The discharge schedule of each of the power consumers may be the prediction of the temporal change acquired by adding the amount of self-consumption of each of the power consumers to the amount of output (for example: the amount of output from the power storage system for another demand response) from the power storage system according to another discharge event. Here, in the discharge schedule, the amount of output in response to the output demand acquired by the acquisition unit 11 is not taken into consideration. Such a method for computing the discharge schedule is a design matter.

It is possible to generate a charge and discharge schedule of the power storage system using the charge schedule and the discharge schedule. Further, it is possible to set the charged power amount [Wh], which is specified on the basis of the generated charge and discharge schedule, of the power storage system at the predetermined timing to the predicted value.

The charge and discharge schedule of the power storage system is generated on the basis of, for example, the following assumptions.

“The power storage system is charged in the first time period according to the charge schedule”.

“In the second time period, a discharged power amount expressed in the discharge schedule is output from the power storage system while the charged power of the power storage system remains”.

The maximum power determination unit 13 determines the maximum power P_{MAX} [W] which can be output from the power storage system in response to the output demand for each power consumer.

P_{MAX} [W] is acquired by subtracting “the amount of output for the power consumption due to the loads (for example: the home appliances, the machines, the facilities, and the like) of the power consumers” from “rated output of the power storage system (rated output of a Power Conditioning System (PCS))”.

It is possible to express P_{MAX} [W] using the time function. Here, the rated output [W] of the power storage system is set to “R” and the time function of the discharged power P_{CON} [W] expressed in the discharge schedule of each power consumer is set to Y(t). In this case, it is possible to set a time function of P_{MAX} to “R—Y(t)”.

The output power determination unit 14 determines “a×X(t)” as the time function of the output power P_{RES} [W], which is output from the power storage system in response to the output demand, for each power consumer. In addition, the output power determination unit 14 determines a value of “a” for each power consumer such that first to third conditions are satisfied.

The first condition is expressed by PH_{MAX}. The first condition is that “an integrated value of “a×X(t)” from t=t₀ (the start time point of the output demand time period) to t=t₁ (the end time point of the output demand time period) is equal to or smaller than PH_{MAX}”.

The second condition is expressed by P_{MAX}. The second condition is that “in all sub-time periods, a statistic value of “a×X(t)” is equal to or smaller than a statistic value of P_{MAX}”.

The sub-time period is acquired by dividing the output demand time period by every predetermined time (for example: every 5 minutes, every 10 minutes, every 15 minutes, or every 30 minutes). Although a type of the statistic value includes an average value, a most frequent value, a median value, or the like as an example, another type may be included. The statistic value of “a×X(t)” and the statistic value of P_{MAX} is a statistic value of the same type.

The second condition may be that “a×X(t) is equal to or smaller than P_{MAX} at any time t”.

The third condition is that “0≤a≤1”.

Further, the output power determination unit 14 may determine the value of “a” so as to satisfy a fourth condition. The fourth condition is that “a sum of the values of “a” of the plurality of power consumers is equal to or smaller than 1”.

The first to third conditions are “conditions for determining feasible control content for each of the power consumer systems 20”. In contrast, the fourth condition is a “condition for realizing stability of the power system”.

The output power determination unit 14 is capable of computing, for example, a maximum value a_{MAX} which satisfies the first to third conditions for each power consumer. Further, in a case where a sum of a_{MAX} of the plurality of power consumers does not exceed 1, the output power determination unit 14 can determine each a_{MAX} as “a” of each of the power consumers.

In contrast, in a case where the sum of a_{MAX} of the plurality of power consumers exceeds 1, the output power determination unit 14 can determine “a” of each of the power consumers, such that the fourth condition is satisfied, by (1) determining a value obtained by reduction from each a_{MAX} as “a” of each of the power consumers or (2) determining each a_{MAX} as “a” of some the power consumers and determining 0 as “a” of the other power consumers.

Here, a reduction method of (1) is illustrated.

“First Reduction Example” In a case where the sum of a_{MAX} of the plurality of power consumers exceeds 1, the output power determination unit 14 determines “a” of each of the power consumers as “k×a_{MAX}”. Here, 0<k<1.

In the example, a value of “k” is common to all the power consumers. That is, the same reduction ratio is applied to all the power consumers.

Further, the output power determination unit 14 determines the value of “k” such that the sum of the values of “a” of the plurality of power consumers is equal to or smaller than 1. For example, the output power determination unit 14 may use, as “k”, a maximum value among values which satisfy a condition that the sum of “k×a_{MAX}” of the plurality of power consumers is equal to or smaller than 1.

“Second Reduction Example”

In a case where the sum of a_{MAX} of the plurality of power consumers exceeds 1, the output power determination unit 14 determines “a” of each of the power consumers as “k×a_{MAX}”. Here, 0<k<1.

In the example, setting is performed such that the value of “k” of the power consumer having a relatively high priority is larger than the value of “k” of the power consumer having a relatively low priority. For example, “(weight value)×m” may be determined as “k” of each power consumer. The weight value is a value determined for each power consumer. “m” is a value commonly applied to all the power consumers.

The output power determination unit 14 determines the value of “m” such that a sum of “(weight value)×m×a_{MAX}” of the plurality of power consumers is equal to or smaller 1. For example, the output power determination unit 14 may use, as “m”, a maximum value among values which satisfy a condition that a sum of “(weight value)×m×a_{MAX}” of the plurality of power consumers is equal to or smaller than 1.

Here, although an example of a method for determining the priority (for example: the weight value) is described, the example is not limited thereto.

“First Priority Determination Example”

The output power determination unit 14 determines a priority according to “an empty situation of a local system (power distribution) to which each of the power consumers is interconnected” in the output demand time period. The output power determination unit 14 determines a higher priority for the power consumer interconnected to the local system which has a large empty space.

The empty situation is expressed by, for example, a size of a value acquired by subtracting a predicted value of a voltage value in the output demand time period from an upper limit voltage value (an upper limit value of an allowable voltage). In a case of the example, the larger the computed value, the larger the empty space. In a case where the priority is determined as above, it is possible to minimize an influence on the local system.

“Second Priority Determination Example”

The output power determination unit 14 determines a higher priority for a power consumer which has higher charge and discharge efficiency of the power storage system. In a case where the priority is determined as above, it is possible to efficiently use energy.

“Third Priority Determination Example”

The output power determination unit 14 determines a higher priority for a power consumer which has higher prediction accuracy of the discharge schedule (for example: discharged power P_{CON} [W]=Y(t)). The prediction accuracy may be replaced by control accuracy or a success rate at a past demand response participation. Computation is possible on the basis of the past performance. In a case where the priority is determined as above, it is possible to reduce deviation between control content, which is determined according to the output demand, of the power storage system and actual output of the power storage system. That is, the accuracy, in which output from the power storage system is performed as the determined control content, increases.

“Fourth Priority Determination Example”

The output power determination unit 14 determines a higher priority for a power consumer whose date of lastly participating in the demand response is old. In a case where the priority is determined as above, it is possible to evenly provide an opportunity to participate in the demand response to the plurality of power consumers.

“Fifth Priority Determination Example”

The output power determination unit 14 determines a higher priority for a power consumer whose advantage generated in the demand response within a fixed period in the past is small. In a case where the priority is determined as above, it is possible to evenly provide the advantage of the demand response to the plurality of power consumers.

“Sixth Priority Determination Example”

The output power determination unit 14 determines the priority by combining some of the first to fifth priority determination examples.

Subsequently, in the above (2), a method for determining the power consumer in which a_{MAX} is determined as “a” will be described.

The output power determination unit 14 determines priorities for the plurality of power consumers using a random method. For example, the above-described methods may be used. Further, the output power determination unit 14 sequentially determines each a_{MAX} as “a” from the power consumer having the high priority. The output power determination unit 14 sequentially determines each a_{MAX} as “a” from the power consumer having the high priority while a condition, in which a sum of a_{MAX} determined as “a” is equal to or smaller than 1, is satisfied. Further, the output power determination unit 14 determines 0 as “a” of remaining power consumers in which each a_{MAX} is not determined as “a”.

Here, a modified example of the power control apparatus 10 of the first example embodiment will be described. The power control apparatus 10 may include an extraction unit that extracts a power consumer who accedes to the output demand from among the plurality of power consumers whenever the output demand is received from the client system 30.

Further, the maximum power amount determination unit 12 may determine the maximum power amount PH_{MAX} [Wh], which can be output from the power storage system in response to the output demand, for each extracted power consumer. That is, the maximum power amount determination unit 12 may not determine the maximum power amount PH_{MAX} [Wh] of a non-extracted power consumer.

In addition, the maximum power determination unit 13 may determine the maximum power P_{MAX} [W], which can be output from the power storage system in response to the output demand, for each extracted power consumer. That is, the maximum power determination unit 13 may not determine the maximum power P_{MAX} [W] of the non-extracted power consumer.

In addition, the output power determination unit 14 may determine “a×X(t)” as the time function of the output power P_{RES} [W] and may determine the value of “a”, for each extracted power consumer. That is, the output power determination unit 14 may not determine the time function of the output power P_{RES} [W] and the value of “a” of the non-extracted power consumer.

Here, setting is performed such that

a power selling unit price of the second time period of each power consumer is V₁,

a power selling unit price, which is acquired in a case where the power is output in response to an output demand from a client (electric utility) of the demand response and the output power is sold to the client, is V₂,

a power purchase unit price of each power consumer in the first time period is V₃, and

a power purchase unit price of each power consumer in the second time period is V₄.

The first time period and the second time period are as being described in the charge schedule of the power storage system.

The power selling unit price V₁ is a price acquired in a case where each power consumer sells the power to the electric utility (which may be the same as or different from the electric utility that makes the output demand) in a normal state in which the output demand from the electric utility does not exist. The power selling unit price V₂ is a price acquired in a case where each power consumer sells the power to the electric utility (the electric utility that makes the output demand) in a special state in which the output demand from the electric utility exists.

The power purchase unit price V₃ is a price acquired in a case where each power consumer purchases the power from a contracted electric utility (which may be the same as or different from the electric utility that makes the output demand) in the first time period. The power purchase unit price V₄ is a price acquired in a case where each power consumer purchases the power from the contracted electric utility (which may be the same as or different from the electric utility that makes the output demand) in the second time period.

The extraction unit extracts, for example, a power consumer which satisfies “V₂>max(V₁, V₄)”. The extraction unit may extract a power consumer which satisfies “V₂>V₃” in addition to the above condition.

In a case where the power consumer is extracted who accedes to the output demand under the above condition and only the extracted power consumer is caused to accede to the output demand, it is possible to secure the advantage of the power consumer obtained by acceding to the output demand.

Even in a case where the extraction is not performed, it is possible to secure the advantage of the power consumer by providing some incentives to a power consumer who has controlled in response to the output demand.

In addition, “the charge schedule of the power storage system” and “the discharge schedule of each of the power consumers”, which are described above, may be generated by the power control apparatus 10 or may be generated by each of the power consumer systems 20. In a case where the schedules are generated by each of the power consumer systems 20, the power control apparatus 10 acquires the schedule generated by each of the power consumer systems 20.

Subsequently, an example of flow of a process performed by the power management system of the example embodiment will be described.

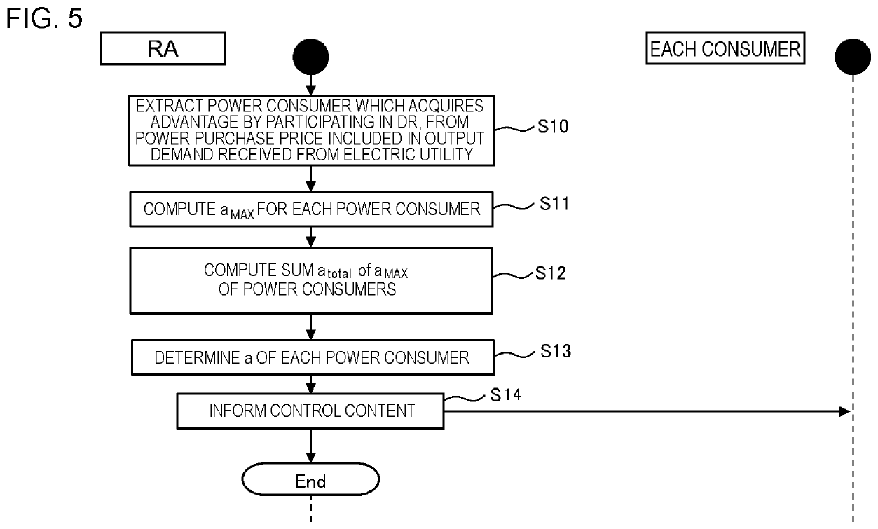

FIG. 5 is a flowchart illustrating the example of the flow of the process of the power management system of the example embodiment. In S10, the power control apparatus 10 extracts a power consumer which acquires the advantage by acceding to the output demand (participating in the DR) on the basis of the power purchase price included in the output demand received from the electric utility.

For example, the above-described power selling unit price V₁, the power purchase unit price V₃, and the power purchase unit price V₄ are previously registered in the power control apparatus 10, for each power consumer. The power purchase price included in the output demand corresponds to the above-described power selling unit price V₂. The power control apparatus 10 extracts a power consumer which satisfies “V₂>max(V₁, V₄)” or a power consumer which satisfies “V₂>V₃” in addition to the above condition.

In S11, the power control apparatus 10 computes the maximum value a_{MAX}, which satisfies the above-described first to third conditions, for each extracted power consumer.

In S12, the power control apparatus 10 computes a sum aₜₒₜₐₗ of a_{MAX} computed for each extracted power consumer.

In S13, the power control apparatus 10 determines “a” of each power consumer using a method according to a magnitude relation between aₜₒₜₐₗ and 1.

In a case where aₜₒₜₐₗ is larger than 1, the power control apparatus 10 may determine a value obtained by reduction from each a_{MAX} as “a” of each of the power consumers. In addition, in the case where aₜₒₜₐₗ is larger than 1, the power control apparatus 10 may determine each a_{MAX} as “a” of some of the power consumers and may determine 0 as “a” of the other power consumers.

In contrast, in a case where aₜₒₜₐₗ is equal to or smaller than 1, the power control apparatus 10 determines each a_{MAX} as “a” of each of the power consumers.

In S14, the power control apparatus 10 transmits information indicative of control content according to the output demand to the power consumer system 20 of the power consumer extracted in S10. The transmitted information includes information indicative of the output demand time period, the time function “a×X(t)” of the output power P_{RES} [W], the value of “a”, and the like. The power consumer system 20 controls the power storage system according to the received information.

Subsequently, advantageous effects of the example embodiment will be described.

In the example embodiment, in a case where the time function of the output demand power P_{DEM} [W] in the output demand from the electric utility is X(t), it is possible to determine “a×X(t)” as the time function of the output power P_{RES} [W] which is output from the power storage system in response to the output demand. Further, it is possible to determine the value of “a” for each power consumer such that the above-described first to third conditions are satisfied.

In a case where the output power P_{RES} [W] of each power consumer is determined as the above, the time period in which the output demand is acceded to is not mixed with a time period in which the output demand is not acceded to in the output demand time period, even in a case of acceding to only part of the output demand from the electric utilities. In addition, in the time period in which the output demand is acceded to, a ratio of acceding to the output demand (a ratio of power, in which the demand is acceded to, in the output demand power) does not change.

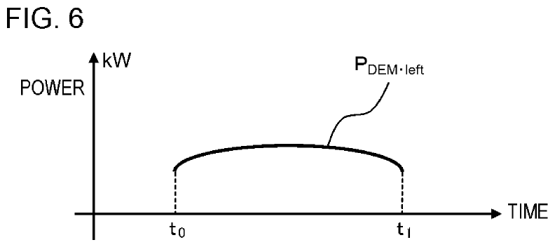

In a case of the example embodiment, it is possible to express a temporal variation in the power (residue), which remains due to the output demand not being acceded to, as “b×X(t)” (0<b<1). That is, the temporal variation in the residue is acquired by compressing the time function X(t) of the output demand power P_{DEM} [W]. For example, in a case where the time function X(t) of the output demand power P_{DEM} [W] is illustrated in FIG. 4, an example of the time function “b×X(t)” of a residue P_{DEM⋅left} [W] is illustrated in FIG. 6.

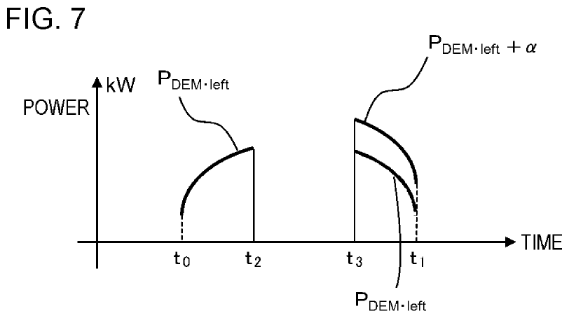

In contrast, an example of the residue P_{DEM⋅left} [W], which is acquired in a case where the time period in which the output demand is acceded to is mixed with the time period in which the output demand is not acceded to, is illustrated in FIG. 7. FIG. 7 illustrates an example in which the output demand is 100% acceded to from t=t2 to t=t3 and the output demand is not at all acceded to during the other time periods.

As illustrated in the drawing, the residue P_{DEM⋅left} [W] may include a sudden increase or decrease. Specifically, the amount of decrease between before and after t=t₂ and the amount of increase between before and after t=t₃ are large.

In addition, in this case, in the time period from t=t₂ to t=t₃ in which the output demand is acceded to, a power consumer whose charged power of the power storage system becomes 0 may be present. In this case, in a time period after t=t₃, the amount of power consumption (+α) of the power consumer is provided using power from the power system instead of power from the power storage system. That is, in the time period after t=t₃, the electric utility should output both the residue P_{DEM⋅left} and power corresponding to the above-described “+a” using any of the power generation systems. In this case, it is understood that the amount of increase becomes further large before and after t=t₃ from the drawing.

That is, “P_{DEM⋅left}+α [W]” may include the more sudden increase or decrease than P_{DEM⋅left} [W]. Therefore, it is difficult to perform output according to the increase or decrease in the power generation system.

According to the example embodiment, it is possible to avoid such a problem.

In addition, in the example embodiment, the maximum power amount determination unit 12 can set “the predicted value of the charged power amount [Wh] of the power storage system at the predetermined timing after the end time point (in FIG. 4, t₁) of the output demand time period”, which is computed on the basis of “the charge schedule of the power storage system” and “the discharge schedule of each of the power consumers”, to PH_{MAX}.

In a case where “a” of the time function “a×X(t)” of the output power P_{RES} [W] is determined by setting “the predicted value of the charged power amount [Wh] of the power storage system at the predetermined timing before the end time point (in FIG. 4, t₁) of the output demand time period” to PH_{MAX}, the power of the power storage system may be exhausted at a stage before the end time point (in FIG. 4, t₁) of the output demand time period. In this case, it is not possible to perform output from the power storage system thereafter. As above, in a case where a method for determining PH_{MAX} is wrong, accuracy of controlling the power storage system as determined content becomes low. In the example embodiment, since it is possible to determine PH_{MAX} using an appropriate method, the accuracy of controlling the power storage system as the determined content becomes high.

The maximum power amount determination unit 12 can use the end time point (in FIG. 4, t₁) of the output demand time period as the predetermined timing. In this case, it is possible to maximize the amount of power (the amount to be output in response to the output demand) to be sold to the electric utility by the power consumer while maintaining the high accuracy of controlling the power storage system as the determined content. As a result, it is possible to maximize the advantage of the power consumer.

In addition, in the example embodiment, it is possible to determine “a” for each power consumer. That is, for each power consumer, it is possible to determine a schedule (P_{RES} [W]=“a×X(t)”) of the power to be output from the power storage system in response to the output demand. In this manner, it is possible to determine a highly feasible schedule of the output power. As a result, the accuracy of controlling the power storage system as the determined content becomes high.

In addition, in the example embodiment, it is possible to determine “a” for each power consumer such that the above-described fourth condition is satisfied. The fourth condition is a “condition for realizing stability of the power system”. In a case where the fourth condition is satisfied, a large amount of power flows to the power system, and thus it is possible to avoid a problem of an excessive power state.

In addition, in the example embodiment, it is possible to determine a maximum value in a range, in which the above-described first to fourth conditions are satisfied, as the value of “a”. In this case, it is possible to maximize the power which is output from the power storage system in response to the output demand. As a result, it is possible to sufficiently secure the advantage of the power consumer.

### Second Example Embodiment

In an example embodiment, each power consumer system 20 (for example, the energy control apparatus) performs a part of the arithmetic process performed by the power control apparatus 10 according to the first example embodiment. The other configurations are the same as in the first example embodiment.

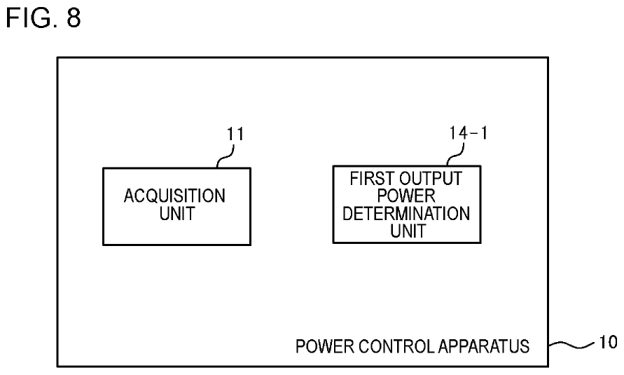

FIG. 8 illustrates an example of a functional block diagram of a power control apparatus of the example embodiment. As illustrated in the drawing, the power control apparatus 10 includes an acquisition unit 11 and a first output power determination unit 14-1. A fact that the power control apparatus 10 of the example embodiment does not include the maximum power amount determination unit 12 and the maximum power determination unit 13 is different from the first example embodiment.

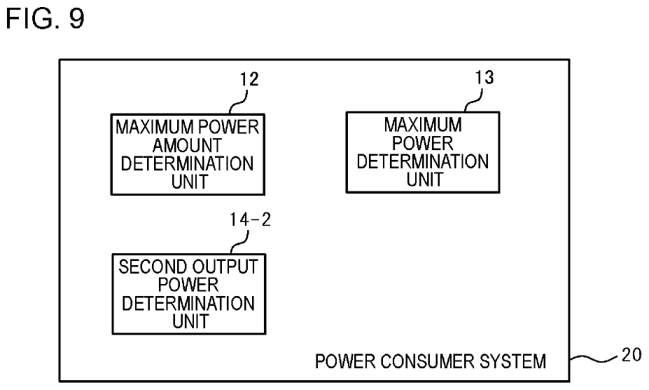

FIG. 9 illustrates an example of a functional block diagram of the power consumer system of the example embodiment. As illustrated in the drawing, the power consumer system 20 includes the maximum power amount determination unit 12, the maximum power determination unit 13, and a second output power determination unit 14-2.

Functional configurations of the acquisition unit 11, the maximum power amount determination unit 12, and the maximum power determination unit 13 are the same as in the first example embodiment.

The first output power determination unit 14-1 and the second output power determination unit 14-2 have some functions of the output power determination unit 14. The second output power determination unit 14-2 computes the maximum value a_{MAX} which satisfies the first to third conditions. Further, the first output power determination unit 14-1 determines “a” of each power consumer so as to satisfy the fourth condition on the basis of a_{MAX} of each of the plurality of power consumers.

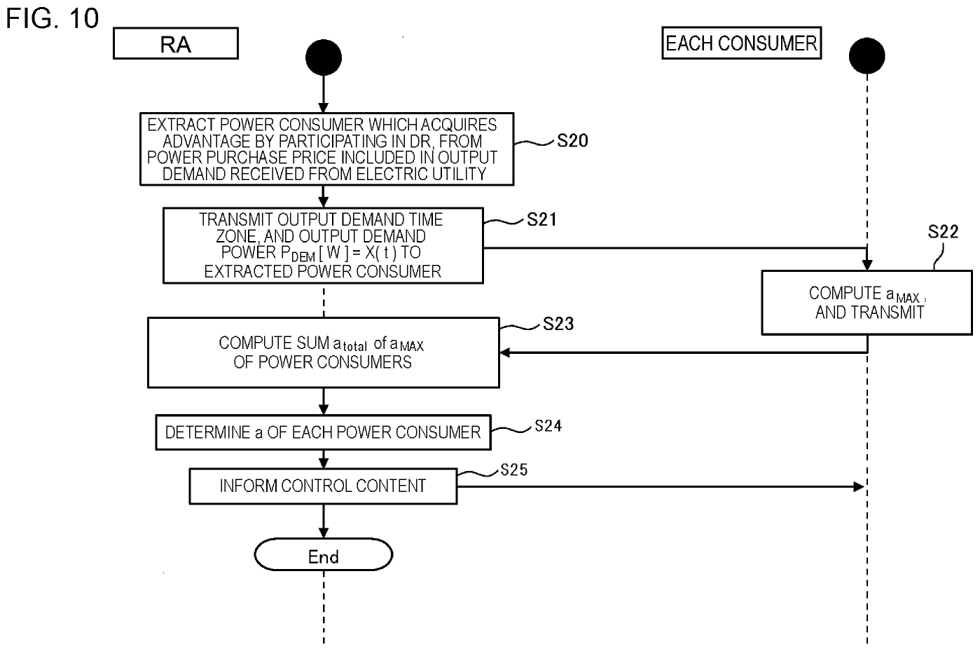

FIG. 10 is a flowchart illustrating another example of a flow of a process performed by a power management system of the example embodiment. In S20, the power control apparatus extracts a power consumer, which acquires advantage by acceding to the output demand (participating in the DR), from the power purchase price included in the output demand received from the electric utility.

For example, the above-described power selling unit price V₁, the power purchase unit price V₃, and the power purchase unit price V₄ are previously registered in the power control apparatus 10, for each power consumer. The power purchase price included in the output demand corresponds to the above-described power selling unit price V₂. The power control apparatus 10 extracts the power consumer which satisfies “V₂>max (V₁, V₄)” or the power consumer which satisfies “V₂>V₃” in addition to the above condition.

In S21, the power control apparatus 10 transmits information indicative of the output demand time period included in the output demand and the time function X(t) of the output demand power P_{DEM} [W] in the output demand time period to the power consumer system 20 of the extracted power consumer.

In S22, each power consumer system 20, which receives the information, computes a maximum value a_{MAX}, which satisfies the above-described first to third conditions, and transmits the maximum value a_{MAX} to the power control apparatus 10.

In S23, the power control apparatus 10 computes a sum aₜₒₜₐₗ of a_{MAX} received from the power consumers.

In S24, the power control apparatus 10 determines “a” of each power consumer using a method according to a magnitude relation between aₜₒₜₐₗ and 1.

In a case where aₜₒₜₐₗ is larger than 1, the power control apparatus 10 may determine a value obtained by reduction from each a_{MAX} as “a” of each of the power consumers. In addition, in the case where aₜₒₜₐₗ is larger than 1, the power control apparatus 10 may determine each a_{MAX} as “a” of some of the power consumers and may determine 0 as “a” of the other power consumers.

In contrast, in a case where aₜₒₜₐₗ is equal to or smaller than 1, the power control apparatus determines each a_{MAX} as “a” of each of the power consumers.

In S25, the power control apparatus 10 transmits information indicative of control content according to the output demand to the power consumer system 20 of the power consumer extracted in S20. The transmitted information includes the value of “a” or the like. The power consumer system 20 controls the power storage system according to the received information.

According to the example embodiment, it is possible to realize the same advantageous effects as in the first example embodiment. In addition, in a case where a part of the arithmetic process is performed by each power consumer system 20, it is possible to reduce processing loads of the power control apparatus 10.

Hereinafter, examples of reference forms will be appended.

1. A power management system including:

an acquisition unit that acquires “X(t)” which is a time function of output demand power P_{DEM} [W] in an output demand time period;

a maximum power amount determination unit that determines a maximum power amount PH_{MAX} [Wh], which can be output from a power storage system in response to an output demand, for each power consumer;

a maximum power determination unit that determines maximum power P_{MAX} [W], which can be output from the power storage system in response to the output demand, for each power consumer; and

an output power determination unit that determines “a×X(t)” as a time function of output power P_{RES} [W], which is output from the power storage system in response to the output demand, for each power consumer, and that determines a value of “a” so as to satisfy a first condition expressed by PH_{MAX}, a second condition expressed by P_{MAX}, and a third condition “0≤a≤1”.

2. The power management system according to 1,

in which the maximum power amount determination unit computes a predicted value of a charged power amount [Wh] of the power storage system at a predetermined timing after an end time point of the output demand time period, for each power consumer, on the basis of a charge schedule of the power storage system and a discharge schedule of each power consumer, and determines the predicted value as PH_{MAX}.

3. The power management system according to 2,

in which the maximum power amount determination unit determines the predicted value of the charged power amount of the power storage system at the end time point of the output demand time period as PH_{MAX}.

4. The power management system according to any one of 1 to 3,

in which in a case where a rated output [W] of the power storage system is set to “R” and a time function of power consumption P_{CON} [W] of the power consumer, which is indicated in the discharge schedule, is set to “Y(t)”, the maximum power determination unit determines “R—Y(t)” as P_{MAX}.

5. The power management system according to any one of 1 to 4,

in which in a case where a start time point of the output demand time period is set to “t₀” and an end time point is set to “t₁”, the output power determination unit determines the value of “a” for each power consumer so as to satisfy the first condition “an integrated value of “a×X(t)” from t=t₀ to t=t₁ is equal to or smaller than PH_{MAX}”.

6. The power management system according to any one of 1 to 5,

in which the output power determination unit computes a statistic value of “a×X(t)” and a statistic value of P_{MAX} for each of a plurality of sub-time periods included in the output demand time period, and determines the value of “a” so as to satisfy the second condition “the statistic value of “a×X(t)” is equal to or smaller than the statistic value of P_{MAX} in all the sub-time periods”.

7. The power management system according to any one of 1 to 5,

in which the output power determination unit determines the value of “a” so as to satisfy the second condition “a×X(t)” is equal to or smaller than P_{MAX} the whole time”.

8. The power management system according to any one of 1 to 7,

in which the output power determination unit determines the value of “a” so as to satisfy a fourth condition “a sum of the values of “a” of a plurality of the power consumers is equal to or smaller than 1”.

9. The power management system according to any one of 1 to 8,

in which the output power determination unit determines, for the each power consumer, a maximum value a_{MAX}, which satisfies the first to the third conditions, as the value of “a”.

10. The power management system according to 9,

in which in a case where a sum of a_{MAX} of the plurality of power consumers exceeds 1, the output power determination unit determines the values of “a” of the power consumers as “k×a_{MAX} (0<k<1)”, and sets a value of “k” to be common to all the power consumers.

11. The power management system according to 9,

in which in a case where a sum of a_{MAX} of the plurality of power consumers exceeds 1, the output power determination unit determines the values of “a” of the power consumers as “k×a_{MAX} (0<k<1)”, and sets a value of “k” of a power consumer having a relatively high priority to be larger than a value of “k” of a power consumer having a relatively low priority.

12. The power management system according to 9,

in a case where a sum of a_{MAX} of the plurality of power consumers exceeds 1, the output power determination unit determines a_{MAX} as the values of “a” of some power consumers having a relatively high priority, and determines “0” as the values of “a” of remaining power consumers.

13. The power management system according to any one of 1 to 12, further including:

a power control apparatus that includes the acquisition unit, and a first output power determination unit which has some functions of the output power determination unit; and

a plurality of power consumer systems that each includes the maximum power amount determination unit, the maximum power determination unit, and a second output power determination unit which has other functions of the output power determination unit.

14. A power control apparatus including:

an acquisition unit that acquires “X(t)” which is a time function of output demand power P_{DEM} [W] in an output demand time period;

a maximum power amount determination unit that determines a maximum power amount PH_{MAX} [Wh], which can be output from a power storage system in response to an output demand, for each power consumer;

a maximum power determination unit that determines maximum power P_{MAX} [W], which can be output from the power storage system in response to the output demand, for each power consumer; and

an output power determination unit that determines “a×X(t)” as a time function of output power P_{RES} [W], which is output from the power storage system in response to the output demand, for each power consumer, and that determines a value of “a” so as to satisfy a first condition expressed by PH_{MAX}, a second condition expressed by P_{MAX}, and a third condition “0≤a≤1”.

15. A power management method executed by a computer, the method including:

acquiring “X(t)” which is a time function of output demand power P_{DEM} [W] in an output demand time period;

determining a maximum power amount PH_{MAX} [Wh], which can be output from a power storage system in response to an output demand, for each power consumer;

determining maximum power P_{MAX} [W], which can be output from the power storage system in response to the output demand, for each power consumer; and

determining “a×X(t)” as a time function of output power P_{RES} [W], which is output from the power storage system in response to the output demand, for each power consumer, and determining a value of “a” so as to satisfy a first condition expressed by PH_{MAX}, a second condition expressed by P_{MAX}, and a third condition “0≤a≤1”.

16. A program causing a computer to function as:

an acquisition unit that acquires “X(t)” which is a time function of output demand power P_{DEM} [W] in an output demand time period;

a maximum power amount determination unit that determines a maximum power amount PH_{MAX} [Wh], which can be output from a power storage system in response to an output demand, for each power consumer;

a maximum power determination unit that determines maximum power P_{MAX} [W], which can be output from the power storage system in response to the output demand, for each power consumer; and

an output power determination unit that determines “a×X(t)” as a time function of output power P_{RES} [W], which is output from the power storage system in response to the output demand, for each power consumer, and that determines a value of “a” so as to satisfy a first condition expressed by PH_{MAX}, a second condition expressed by P_{MAX}, and a third condition “0≤a≤1”.

This application claims priority based on Japanese Patent Application No. 2017-118361 filed on Jun. 16, 2017, and the whole disclosure is incorporated here.

1. A power management system comprising:
at least one memory configured to store one or more instructions; and
at least one processor configured to execute the one or more instructions to:
acquire “X(t)” which is a time function of output demand power P_{DEM} [W] in an output demand time period;
determine a maximum power amount PH_{MAX} [Wh], which can be output from a power storage system in response to an output demand, for each power consumer;
determine maximum power P_{MAX} [W], which can be output from the power storage system in response to the output demand, for each power consumer; and
determine “a×X(t)” as a time function of output power P_{RES} [W], which is output from the power storage system in response to the output demand, for each power consumer, and determine a value of “a” so as to satisfy a first condition expressed by PH_{MAX}, a second condition expressed by P_{MAX}, and a third condition “0≤a≤1”.

2. The power management system according to claim 1,
wherein the processor is further configured to execute the one or more instructions to compute a predicted value of a charged power amount [Wh] of the power storage system at a predetermined timing after an end time point of the output demand time period, for each power consumer, on the basis of a charge schedule of the power storage system and a discharge schedule of each power consumer, and determine the predicted value as PH_{MAX}.

3. The power management system according to claim 2,
wherein the processor is further configured to execute the one or more instructions to determine the predicted value of the charged power amount of the power storage system at the end time point of the output demand time period as PH_{MAX}.

4. The power management system according to claim 1,
wherein the processor is further configured to execute the one or more instructions to determine “R—Y(t)” as P_{MAX}, in a case where a rated output [W] of the power storage system is set to “R” and a time function of power consumption P_{CON} [W] of the power consumer, which is indicated in a discharge schedule, is set to “Y(t)”.

5. The power management system according to claim 1,
wherein the processor is further configured to execute the one or more instructions to determine the value of “a” for each power consumer so as to satisfy the first condition “an integrated value of “a×X(t)” from t=t₀ to t=t₁ is equal to or smaller than PH_{MAX}”, in a case where a start time point of the output demand time period is set to “t₀” and an end time point is set to “t₁”.

6. The power management system according to claim 1,
wherein the processor is further configured to execute the one or more instructions to compute a statistic value of “a×X(t)” and a statistic value of P_{MAX} for each of a plurality of sub-time periods included in the output demand time period, and determine the value of “a” so as to satisfy the second condition “the statistic value of “a×X(t)” is equal to or smaller than the statistic value of P_{MAX} in all the sub-time periods”.

7. The power management system according to claim 1,
wherein the processor is further configured to execute the one or more instructions to determine the value of “a” so as to satisfy the second condition “a×X(t)” is equal to or smaller than P_{MAX} the whole time”.

8. The power management system according to claim 1,
wherein the processor is further configured to execute the one or more instructions to determine the value of “a” so as to satisfy a fourth condition “a sum of the values of “a” of a plurality of the power consumers is equal to or smaller than 1”.

9. The power management system according to claim 1,
wherein the processor is further configured to execute the one or more instructions to determine, for the each power consumer, a maximum value a_{MAX}, which satisfies the first to the third conditions, as the value of “a”.

10. The power management system according to claim 9,
wherein the processor is further configured to execute the one or more instructions to determine the values of “a” of the power consumers as “k×a_{MAX} (0<k<1)”, and set a value of “k” to be common to all the power consumers, in a case where a sum of a_{MAX} of the plurality of power consumers exceeds 1.

11. The power management system according to claim 9,
wherein the processor is further configured to execute the one or more instructions to determine the values of “a” of the power consumers as “k×a_{MAX} (0<k<1)”, and set a value of “k” of a power consumer having a relatively high priority to be larger than a value of “k” of a power consumer having a relatively low priority, in a case where a sum of a_{MAX} of the plurality of power consumers exceeds 1.

12. The power management system according to claim 9,
wherein the processor is further configured to execute the one or more instructions to determine a_{MAX} as the values of “a” of some power consumers having a relatively high priority, and determine “0” as the values of “a” of remaining power consumers, in a case where a sum of a_{MAX} of the plurality of power consumers exceeds 1.

13. The power management system according to claim 1, comprising:
a power control apparatus and
a plurality of power consumer systems.

14. A power control apparatus comprising:
at least one memory configured to store one or more instructions; and
at least one processor configured to execute the one or more instructions to:
acquire “X(t)” which is a time function of output demand power P_{DEM} [W] in an output demand time period;
determine a maximum power amount PH_{MAX} [Wh], which can be output from a power storage system in response to an output demand, for each power consumer;
determine maximum power P_{MAX} [W], which can be output from the power storage system in response to the output demand, for each power consumer; and
determine “a×X(t)” as a time function of output power P_{RES} [W], which is output from the power storage system in response to the output demand, for each power consumer, and determine a value of “a” so as to satisfy a first condition expressed by PH_{MAX} a second condition expressed by P_{MAX}, and a third condition “0≤a≤1”.

15. A power management method executed by a computer, the method comprising:
acquiring “X(t)” which is a time function of output demand power P_{DEM} [W] in an output demand time period;
determining a maximum power amount PH_{MAX} [Wh], which can be output from a power storage system in response to an output demand, for each power consumer;
determining maximum power P_{MAX} [W], which can be output from the power storage system in response to the output demand, for each power consumer; and
determining “a×X(t)” as a time function of output power P_{RES} [W], which is output from the power storage system in response to the output demand, for each power consumer, and determining a value of “a” so as to satisfy a first condition expressed by PH_{MAX}, a second condition expressed by P_{MAX}, and a third condition “0≤a≤1”.

16. (canceled)
